(19) United States
(12) Patent Application Publication
(10) Pub. No.: US 2009/0299854 A1
(43) Pub. Date: Dec. 3, 2009

(54) MEANS FOR TRACKING COSTS ASSOCIATED WITH SALES LEAD SOLICITATION

(76) Inventors: Jonathan Olawski, Scottsdale, AZ (US); Gary Bialowas, Scottsdale, AZ (US)

Correspondence Address: Kunzler & McKenzie, 8 EAST BROADWAY, SUITE 600, SALT LAKE CITY, UT, 84111, US

(21) Appl. No.: 12/477,804

(22) Filed: Jun. 3, 2009

Related U.S. Application Data
(60) Provisional application No. 61/058,510, filed on Jun. 3, 2008.

(51) Int. Cl. G06Q 30/00; G06F 17/00; G06Q 10/00; G06F 3/048

(52) U.S. Cl. 705/14.53; 705/400; 715/764

(57) ABSTRACT

A computer-implemented method for automatically tracking the cost of sales leads to a seller client, the steps of said method comprising: 1) accessing a sales lead data storage repository, wherein the sales lead comprises information about a potential customer, said information comprising one or more of: age, address, gender, credit rating, email, telephone number, commercial or residential nature, title in residence, size of residence, price of residence, income, education, purchasing interests, and purchasing practices; 2) receiving cost information comprising one or more of: costs of generating a sales lead, costs of purchasing the sales lead, and costs of soliciting the potential customer; 3) setting a cumulative cost indicator associated with the sales lead in response to receiving the cost information; and 4) allowing one or more seller clients to access the cost information.

### CROSS-REFERENCES TO RELATED APPLICATIONS

This application claims priority to U.S. Provisional Patent Application No. 61/058,510 entitled MEANS FOR TRACKING COSTS ASSOCIATED WITH SALES LEAD SOLICITATION and filed on Jun. 3, 2008 for Jonathan Olawski and Gary Bialowas, which is incorporated herein by reference.

### FIELD OF THE INVENTION

This invention relates to computer systems, more particularly using a computer system to track the cost of soliciting a sales lead.

### BACKGROUND

### Description of the Related Art

Historically sales people of service industries have used traditional advertising venues such as phone books and billboards to procure customers. For example, a service provider may purchase advertisement space in a phone book (e.g. YELLOW PAGES) and when a potential customer sought that particular service they would see the contact information for the service provider and possibly contact the service provider. In this example, the phone book advertisement generated a sales lead, which the service provider was able to pursue.

However, with the rise of the Internet, more people are looking to the internet to search for services. Following the possible customers, service providers have created internet sites that help them generate sales leads. However, the internet is new, and service providers struggle to optimize their ability to capitalize on the generated sales leads. One of the most important factors to optimize is the cost of prosecuting the generated sales leads. To prosecute a generated sales lead through the internet requires several steps. Each step has an associated cost, and there is no system which presently tabulates all the associated costs of securing a sales lead. Because of this inability to calculate the accumulated cost of pursuing a sales lead, service providers are unable to streamline their solicitation process.

### SUMMARY

From the foregoing discussion, it should be apparent that a need exists for an apparatus, system, and method to track costs associated with sales lead solicitation. It is the object of the present invention to provide such a method and system.

The present invention has been developed in response to the present state of the art, and in particular, in response to the problems and needs in the art that have not yet been fully solved. Accordingly, the present invention has been developed to provide an apparatus, system, and method for tracking costs associated with sales lead solicitation that overcome many or all of the above-discussed shortcomings in the art.

The apparatus to automatically track the cost of sales leads to a seller client is provided with a plurality of modules configured to functionally execute the necessary steps of tracking the cost of sales. These modules in the described embodiments include an access module configured to access a sales lead data storage repository, wherein the sales lead comprises information about a potential customer; a reception module configured to receive cost information comprising one or more of: costs of generating a sales lead, costs of purchasing the sales lead, and costs of soliciting the potential customer; a configuration module configured to set a cumulative cost indicator associated with the sales lead in response to receiving the cost information; and an allowance module configured to allow one or more seller clients to access the cost information.

In a further embodiment, the information may comprise one or more of: age, address, gender, credit rating, email, telephone number, commercial or residential nature, title in residence, size of residence, price of residence, income, education, purchasing interests, and purchasing practices.

A method of the present invention is also presented for automatically tracking the cost of sales lead to a seller client. The method in the disclosed embodiments substantially includes the steps necessary to carry out the functions presented above with respect to the operation of the described apparatus and system. In one embodiment, the method includes accessing a sales lead data storage repository, wherein the sales lead comprises information about a potential customer, said information comprising one or more of: age, address, gender, credit rating, email, telephone number, commercial or residential nature, title in residence, size of residence, price of residence, income, education, purchasing interests, and purchasing practices; receive cost information comprising one or more of: costs of generating a sales lead, costs of purchasing the sales lead, and costs of soliciting the potential customer; set a cumulative cost indicator associated with the sales lead in response to receiving the cost information; and allow one or more seller clients to access the cost information.

The method may further comprise assembling the sales lead data into a sales campaign. In certain embodiments, the cumulative cost indicator may be associated with the sales campaign rather than the sales lead.

In at least one embodiment, setting the cumulative cost indicator comprises setting a plurality of cumulative cost indicators each associated with a different seller client in a seller client list. Further, the method may comprise notifying one or more seller clients that the cumulative cost indicator has been set.

In another embodiment, the method further comprises notifying the one or more seller clients that cost information is available in response to receiving the cost information.

In certain embodiments, the method further comprises prompting a human being via a graphical user interface (GUI) to select one or more of: 1) costs incurred per salesperson in soliciting one or more sales leads; 2) costs incurred per sales lead by a seller; and 3) costs incurred per campaign by a seller. The method also further comprises displaying via the GUI one or more of: 1) costs incurred by a single salesperson in soliciting one or more sales leads in response to the human being selecting costs incurred per salesperson in soliciting one or more sales leads when prompted; 2) costs incurred per sales lead by a seller in response to the human being selecting costs incurred per sales lead by a seller when prompted; and 3) costs incurred per sales campaign by a seller in response to the human being selecting costs incurred by sales campaign by a seller when prompted.

The method may also comprise systematically repeating the steps of claim 1 for each seller in a seller list. Further, the sales lead may comprise a computer database entry stored in one or more computer readable files on a computer readable storage device.

In certain embodiments, a computer program product comprising a computer readable medium having computer usable program code executable to perform operations for tracking costs associated with sales lead solicitation, the operations of the computer program product may comprise accessing a sales lead data storage repository, wherein the sales lead comprises information about a potential customer, said information comprising one or more of: age, address, gender, credit rating, email, telephone number, commercial or residential nature, title in residence, size of residence, price of residence, income, education, purchasing interests, and purchasing practices; receive cost information comprising one or more of: costs of generating a sales lead, costs of purchasing the sales lead, and costs of soliciting the potential customer; setting a cumulative cost indicator associated with the sales lead in response to receiving the cost information; and allowing one or more seller clients to access the cost information.

The computer-readable media may also cause the computing device to assemble the sales lead data into a sales campaign. Further, the cumulative cost indicator may be associated with the sales campaign rather than the sales lead. Also, setting the cumulative cost indicator may comprise setting a plurality of cumulative cost indicators each associated with a different seller client in a seller client list.

In another embodiment, the computer-readable media may cause the computing device to notify one or more seller clients that the cumulative cost indicator has been set. Further, the computer-readable media may cause the computing device to notify the one or more seller clients that cost information is available in response to receiving the cost information.

In certain embodiments, the computer-readable media may cause the computing device to prompt a human being via a graphical user interface (GUI) to select one or more of: 1) costs incurred per salesperson in soliciting one or more sales leads; 2) costs incurred per sales lead by a seller; and 3) costs incurred per campaign by a seller. Further, the computer-readable medium may cause the computing device to display via the GUI one or more of: 1) costs incurred by a single salesperson in soliciting one or more sales leads in response to the human being selecting costs incurred per salesperson in soliciting one or more sales leads when prompted; 2) costs incurred per sales lead by a seller in response to the human being selecting costs incurred per sales lead by a seller when prompted; and 3) costs incurred per sales campaign by a seller in response to the human being selecting costs incurred by sales campaign by a seller when prompted.

In a further embodiment, the computer-readable media may cause the computing device to systematically repeat the steps of claim 1 for each seller in a seller list. Also, the sales lead may comprise a computer database entry stored in one or more computer readable files on a computer readable storage device.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram illustrating one embodiment of a computer system that tracks the cost of soliciting sales leads in accordance with the present invention;

FIG. 2 is a schematic block diagram illustrating one embodiment of a cost tracker in accordance with the present invention;

FIG. 3A is a diagram illustrating one embodiment of a sales campaign comprising multiple sales leads structured within a computer readable file;

FIG. 3B is a block diagram illustrating a plurality of sales campaigns comprising sales leads and cost information in accordance with the present invention;

FIG. 4 is a flow chart of a method of tracking intermittent sales lead costs in accordance with the present invention;

FIG. 5 is a user screen in a generic browser showing cost information associated with a plurality of sales leads in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable media.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any form capable of storing machine-readable instructions on a digital processing apparatus. A computer readable medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

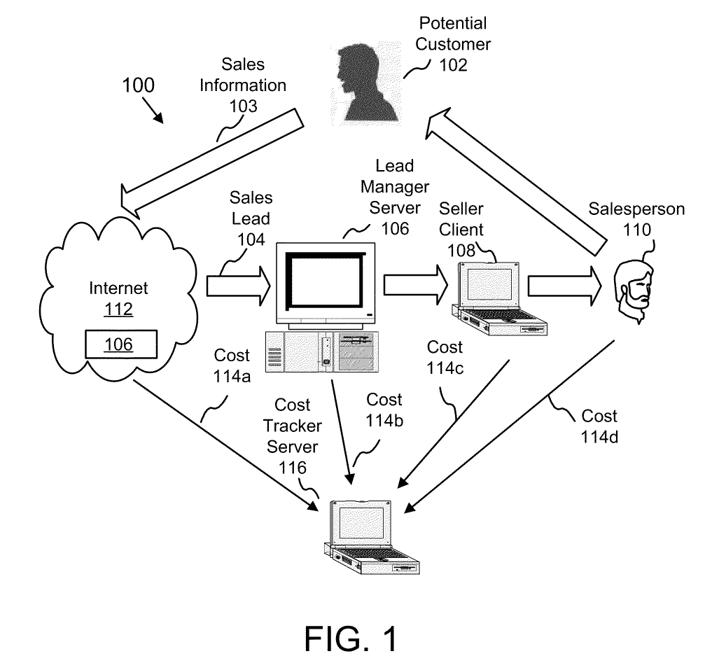

FIG. 1 is a block diagram illustrating one embodiment of a computer system that tracks the cost of sales leads in accordance with the present invention. FIG. 1 comprises a potential customer 102, and a computer system 100, which computer system comprises sales information 103, a sales lead 104, a lead manager server 106, a seller client 108, a salesperson 110, an Internet 112, a cost 114a, a cost 114b, a cost 114c, a cost 114d, and a cost tracker server 116.

The potential customer 102 may be any person, company or organization that is potentially a customer of another person, company or organization.

The system 100 includes sales information 103. The sales information 103, in this embodiment, comprises information about the potential customer 102 (the “information 103”). The information 103 may include one or more of: age, address, gender, credit rating, email, telephone number, commercial or residential nature, title in residence, size of residence, price of residence, income, education, purchasing interests, purchasing practices, and the like.

The information 103 may be generated or collected through any number of processes as are well-known to those of skill in the art, including through cost-per-click (CPC) advertising or cost-per-impression (CPI) advertising on the Internet 112, through telephonic discussions initiated by the potential customer 102 or another party, email solicitations, direct mailers, and the like. In the present embodiment, directed advertising may collect, compile, and relay the information 103 to the lead manager server 106 in the form of a sales lead 104.

The system 100 includes a sales lead 104. The sales lead 104, in this embodiment, is a computer readable file transmittable over a signal bearing medium and storable on a computer readable storage. The sales lead 104 comprises the information 103, as well as other information that may be useful to a seller client 108 in providing services to the potential customer 102.

In some embodiments, the sales lead 104 may comprise a lead value indicator, settable by the lead manager server 106 to indicate the seller client 108 that is scheduled to receive the sales lead 104. The lead value indicator may also indicate a general estimated monetary value of the sales lead 104 to the seller clients 108 that communicate with the lead manager server 106.

In the shown embodiment, the sales lead 104 comprises a cumulative cost indicator, settable by either the lead manager server 106 or the seller client 108 salesperson. The cumulative cost indicator keeps a running tally of the costs incurred in generating and prosecuting the sales lead 104. In some embodiments, the sales lead 104 may comprise an array of cumulative cost indicators for tracking costs at various phases of the sales lead 104 procurement.

The system 100 includes a lead manager server 106. In the shown embodiment, the lead manager server 106 comprises a computer program running on one or more data processing devices (DPDs), such as a server, computer workstation, router, mainframe computer, or the like. In various embodiments, the DPD comprises one or more processors. The processor is a computing device well-known to those in the art and may include an application-specific integrated circuit (“ASIC”).

In the present invention, the lead manager server 106 may route the sales lead 104 to another DPD in communication with the lead manager server 106, including the seller client 108.

In certain embodiments, the lead manager server 106 may notify the seller client 108 via email that the sales lead 104 is available for download or transmittal. In other embodiments, the seller client 108 may request information from the lead manager server 106 over a distributed network to which the seller clients 108 and sales lead manager server 106 are mutually coupled. In various embodiments, a large plurality of seller clients may be in logical communication with the lead manager server 106 through a networked environment, such as local area network (LAN) or wide area network (WAN). Further, the lead manager server 106 may make available sales leads 104 which satisfy a criteria predetermined by the seller client 108 or by the lead manager server 106, and may make unavailable sales leads 104 that fail to satisfy the criteria predetermined by the seller client 108.

The system 100 includes a seller client 108. In the shown embodiment, the seller client 108 comprises a DPD controlled by a company interested in acquiring potential customers 102. The DPD may offer a graphical user interface (GUI) coupled to the DPD. The seller client 108 is configured to retrieve and/or receive the sales lead 104 from, or through, the lead manager server 106. In some embodiments, the seller client 108 may be configured to receive the sales lead 104 as an email attachment using variations of the Simple Mail Transfer Protocol (SMTP), Internet Message Access Protocol (IMAP), Post Office Protocol (POP), or other protocols well-known to those of skill in the art.

In some embodiments, the seller client 108, which communicates with the lead manager server 106, may be assigned a unique identifier. For sales leads 104 that satisfy the predetermined criteria of a particular seller client 108, the lead manager server 106 may set the sales leads' 104 lead value indicators to indicate the seller client 108 to whom the sales lead 104 is scheduled for delivery, or may set the lead value indicator in such a manner so as to facilitate the collection of all sales leads satisfying a predetermined criteria for a particular seller client 108 into a sales campaign.

The system 100 includes a salesperson 110. The salesperson 110, in this embodiment, is a human agent associated with the seller client 108. The salesperson 110 may contact the potential customer 102 by phone, email, facsimile or the like. In an alternative embodiment, the salesperson 110 may comprise another DPD, such as an auto-dialer.

The system 100 includes an Internet 112. The Internet 112 may be collection of interconnected computer networks linked by ethernet cables, wireless connections, or the like, such as the world-wide-web.

The system 100 includes a cost 114a. The cost 114a is a monetary cost realized from collecting and compiling the sales lead 104 on the Internet 112. The cost 114a is relayed by the lead manager server 106 to the cost tracker server 116. In alternative embodiments, the cost 114a may be a cost realized from collecting and compiling a sales campaign on the internet 112 rather than a sales lead 104.

The system 100 includes a cost 114b. The cost 114b is a monetary cost to one or more of the lead manager server 106, the seller client 108, and the salesperson 110, realized from acquiring the pre-compiled sales lead 104 from the Internet 112 after storing, analyzing and querying the sales lead 104. In some embodiments, the sales lead 104 may be acquired from a third-party in communication with the Internet 112. The cost 114b is relayed by the lead manager server 106 to the cost tracker server 116 after the cost 114b is incurred. In alternative embodiments, the cost 114b may be a cost realized from acquiring a sales campaign off the internet 112 rather than a sales lead 104.

The system 100 may include a cost 114c. The cost 114c is a monetary cost realized by the seller client 108 in acquiring the sales lead 104 from the lead manager server 106. The cost 114c is relayed by the lead manager server 106 or the seller client 108 to the cost tracker server 116 after the cost 114c is incurred. In alternative embodiments, the cost 114c may be a cost realized in acquiring a sales campaign from the internet 112 rather than a sales lead 104.

The system 100 includes a cost 114d. The cost 114d is a monetary cost realized by the salesperson 110 or the seller client 108 in soliciting the potential customer 102 using the information 103. The cost 114d is relayed by the salesperson 110, the seller client 108 or the lead manager server 106 to the cost tracker server 116 after the cost 114d is incurred. The cost 114d may be assumed by the seller client 108 in addition to the cost 114c. In alternative embodiments, the costs 114d may be a cost realized from soliciting a plurality of sales leads 104 within a sales campaign.

The costs 114a-d represent the cost(s) incurred in soliciting the sales lead 104 in this embodiment. In other embodiments, additional costs may be sent to the cost tracker server 116 at different stages in the solicitation process. Other stages in the solicitation process may include the cost of initially contacting the potential customer 102, the cost of surveying property of the potential customer 102, the cost of generating a quote for the potential customer 102, the cost of book and scheduling service for the potential customer 102, the cost of losing the potential customer 102, and the like.

In further embodiments, the costs 114a-d may comprise information that is additional to the cost information, such additional information may include other types of data useful to tracking a seller client's 108 efficiency in acquiring sales leads 104, such as the date the sales lead 104 was acquired, the date the sales lead 104 was first contacted, the date of the first sale by the seller client 108 to the potential customer 102, and the like. In still further embodiments, the additional information may be included in the sales lead 104 rather than the costs 114a-d.

The system 100 includes a cost tracker server 116. The cost tracker server 116, in various embodiments, comprises an apparatus such as a DPD, a system, a computer program product, services offering, or the like configured to collect and track the costs associated with prosecuting sales leads 104. The cost tracker server 116 may be internal or external to the lead manager server 106.

In various embodiments, the cost tracker server 116 is in logical communication with the lead manager server 106 and/or the seller client 108 and/or the salesperson 110 through a networked environment, such as local area network (LAN) or wide area network (WAN).

The cost tracker server 116 may be configured to interact with the seller client 108 through a graphical user interface (GUI) coupled to the DPD via web-based software over the Internet 112. In some embodiments, the cost tracker server 116 may be configured to communicate cumulative cost information to the seller client 108 via email using variations of the Simple Mail Transfer Protocol (SMTP), Internet Message Access Protocol (IMAP), Post Office Protocol (POP), or other protocols well-known to those of skill in the art.

The cost tracker server 116 may be further configured to interact with seller clients 108 in response to receiving the costs 114a-d. In some embodiments, the cost tracker server 116 may notify the seller client 108 each time new costs 114a-d are received. In other embodiments, the cost tracker server 116 may update the cumulative cost information displayed to the seller client 108 through the GUI in response to receiving costs 114. In still further embodiments, the cost tracker server 116 may notify the potential customer 102 that the potential customer 102 is progressing through a certain phase in the solicitation process, e.g. that the salesperson 110 has received the sales information 103 and will soon be calling, or that the seller client 108 has received the sales lead 104.

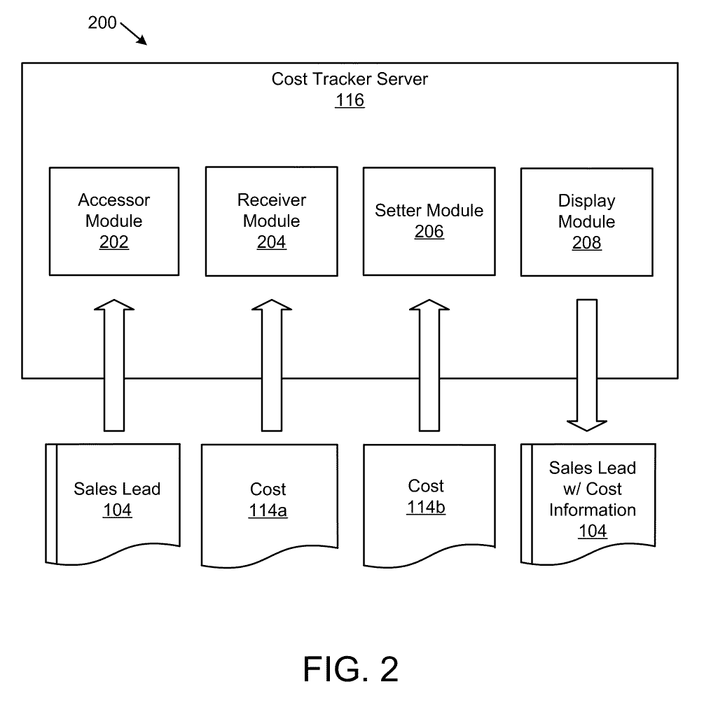

Referring now to FIG. 2, an apparatus 200 for tracking the cost of soliciting sales leads. FIG. 2 is a schematic block diagram illustrating one embodiment of a cost tracker in accordance with the present invention. The apparatus 200 includes a cost tracker server 116 comprising an accessor module 202, a receiver module 204, a setter module 206, a display module 208, a cost 114a, a cost 114b, and a sales lead 104.

The apparatus 200 includes an accessor module 202 for accessing the sales lead 104. The accessor module 202 reads the information constituting the sales lead 104, which is substantially described above in relation to FIG. 1. In the shown embodiment, the sales lead 104 comprises a computer readable file written in computer readable storage. The accessor module 202 reads the sales lead 104 and the information 103 within the sales lead 104. The accessor module 202 may comprise a peripheral device which is internal or external to the cost tracker server 116, such as a disk-drive. The accessor module 202 may comprise the hardware, software and/or firmware necessary to read block storage or content-addressable storage as will be recognizable to those of skill in the art.

The apparatus 200 includes a receiver module 204 for receiving cost information. The receiver module 204, in this embodiment, comprises the hardware, software and/or firmware necessary to receive the costs 114a, 114b incurred in generating, obtaining and soliciting the sales lead 104. In the shown embodiment, the costs 114a, 114b comprise computer readable files transmitted over a signal bearing medium to the receiver module 204 by the lead manager server 106, the seller client 108, the salesperson 110, other third-parties, or the like.

The receiver module 204 may receive the entire sales lead 104 in the form of a computer file, or may receive the information 103 forming the sales lead 104 in pieces from an outside data collector. The receiver module 204 may be in communication with data collectors over a communication bus, wirelessly using a scanner or transceiver, or via a network, including the Internet 112. The other sources and data collectors may be internal or external to the cost tracker server 116. The other sources and data collectors may include devices, systems, individuals, or the like, which convey the sales lead 104, in whole or in part, in real time or delayed time to the lead manager server 106 and/or the cost tracker server 116 for later communication to the seller client 108. One of skill in the art will recognize other ways of configuring the receiver module 204 to receive and collect the sales lead 104.

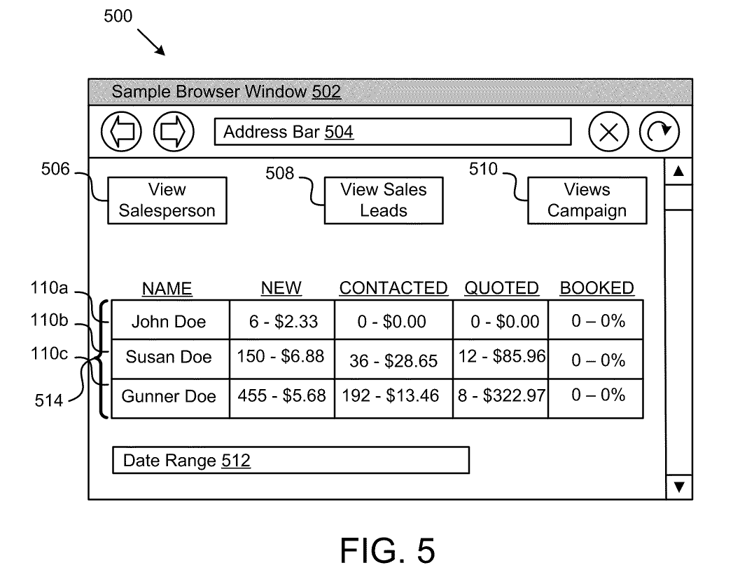

The apparatus 200 includes a setter module 206 for setting a cumulative cost indicator associated with the sales lead 104 in response to the receiver module 204 receiving cost information. The cumulative cost indicator is further described below in relation to FIGS. 1 and 5.

The apparatus 200 includes a display module 208 for displaying information associated with the costs 114a, 114b and with the sales lead 104. The display module 208 dynamically displays cost information derived from the cumulative cost indicator and costs 114a, 114b to the seller client 108 or the salesperson 110 with visual or tactile images or text, data streams, or audio. Specific methods of displaying cost information are further described below in relation to FIG. 5.

The display module 208 may be digital or analog. In some embodiments, the display may be a cathode ray tube (“CRT”), a liquid crystal display (“LCD”), a plasma display panel (“PDP”), a light emitting diode or series thereof (“LED”), or the like. Alternatively, or in addition, the display module 208 may include an audio speaker for providing audio information.

In the shown embodiment, the sales lead 104 comprises the cost information. The salesperson 110 may view the cost information on a display coupled to the cost tracker server 116, or may view the cost information via a display on a separate DPD which receives the cost information via email with the sales lead 104.

In some embodiments, the display module 208 transmits cost information via the Internet 112 to the salesperson 110 or seller client 108. One of skill in the art will recognize other types of displays which may be used to communicate cost information to the seller client 108 and/or the salesperson 110.

The apparatus 200 includes a cost 114a. The cost 114a is substantially described above in relation to FIG. 1.

The apparatus 200 includes a cost 114b. The cost 114b is substantially described above in relation to FIG. 1.

The apparatus 200 includes a sales lead 104. The sales lead 104 is substantially described above in relation to FIG. 1.

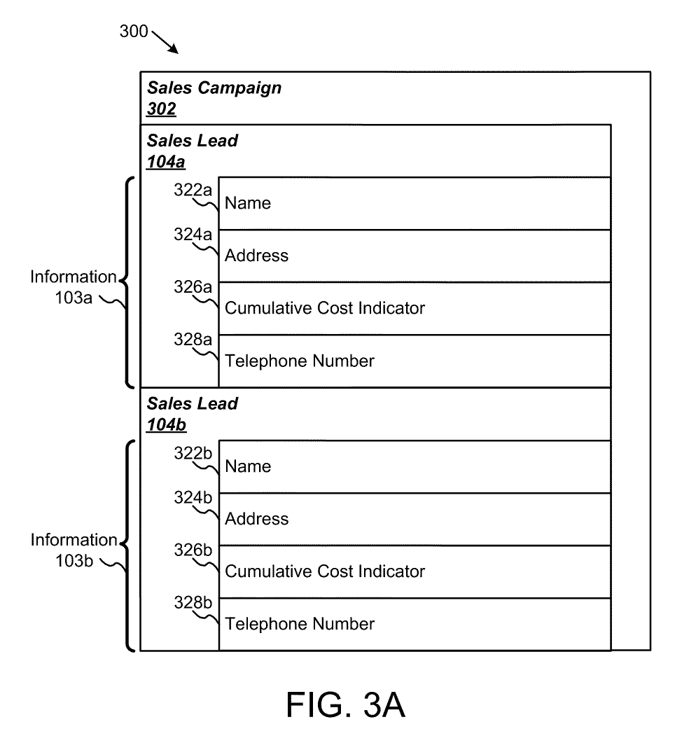

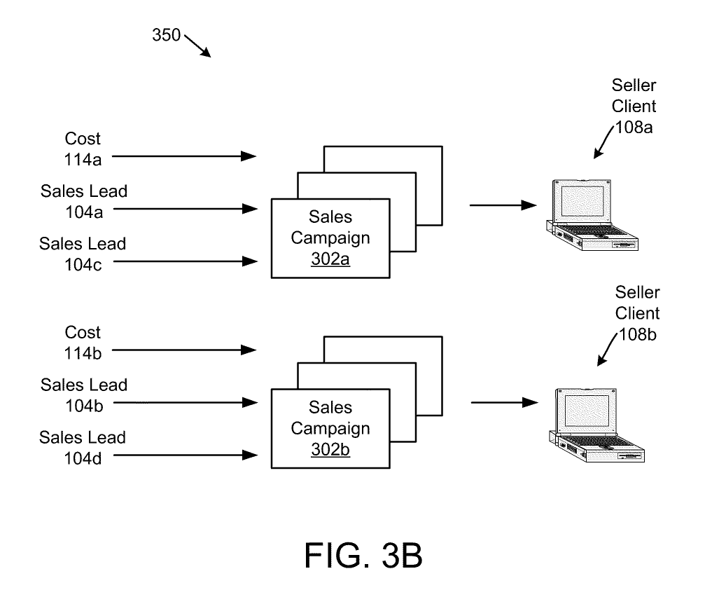

Referring now to FIG. 3A, a computer program product comprising a computer readable file 300 stored on a tangible medium for tracking costs incurred in sales lead solicitation. FIG. 3A depicts one embodiment of a sales campaign 302, the sales campaign comprising a sales lead 104a, a sales lead 104b, sales information 103a, sales information 103b, a name 322a, a name 322b, an address 324a, an address 324b, a cumulative cost indicator 326a, a cumulative cost indicator 326b, a telephone number 328a, and a telephone number 328b.

The sales campaign 302 may comprise all sales leads 104a-b generated over a predefined or undefined period of time or only those sales leads 104a-b that satisfy a predetermined criteria. The sales campaign 302 may alternatively or additionally comprise only those sales leads 104a-b scheduled for delivery to one or more of a plurality of seller clients 108.

The sales campaign 302 comprises a record of one or more sales leads 104a-b. The sales campaign 302 preferably comprises a structured computer-readable file, but may also comprise a book, audio recording, video, digital image, or the like. The sales campaign 302 may comprise a relational computer database managed by a relational database management system (RDBMS) or a database management system (DBMS), such as Oracle, DB2, Firebird, SQL, or other DBMSs as well-known to those of skill in the art.

The sales leads 104a-b may comprise information 103a-b. The information 103a-b comprises data associated with potential customers 102, including names 322a-b, addresses 324a-b, and telephone numbers 328a-b. The information 103a-b is substantially described above with respect to FIGS. 1-2.

In this embodiment, the sales leads 104a-b may further comprise cumulative cost indicators, the cumulative cost indicators comprising cost information 114a-d, the cost information 114a-d substantially described above in relation to FIG. 1-2. The cumulative cost indicators, in the shown embodiment, contain a running total of the costs incurred in generating, obtaining and prosecuting the sales leads 104a-b. In alternative embodiments, the sales leads 104a-b may contain a plurality of cumulative cost indicators comprising costs incurred by a plurality of salesperson 110.

Referring now to FIG. 3B, a system for tracking costs incurred in sales lead solicitation. FIG. 3B is a block diagram illustrating a plurality of sales campaigns comprising sales leads and costs organized in accordance with the present invention. The system 350 includes a sales campaign 302a, a sales campaign 302b, seller clients 108a-b, sales leads 102a-d, and costs 114a-b.

In the shown embodiment, the sales campaigns 302a-b comprise structured computer-readable files organized and indexed in a database and saved in computer-readable storage further described above in relation to FIG. 3A above. Each of the sales campaigns 302a-b comprise one or more of sales leads 104a-d which have satisfied a predetermined criteria for one of seller clients 108a-b. The storage containing the sales campaigns 302a-b may be coupled to the lead manager server 106 for later transmission to seller clients 108, or the sales campaigns 302a-b may be coupled to DPDs representing, or under the control of, the seller clients 108.

In this embodiment, the seller clients 108a-b are each subscribers of the lead manager server 106, substantially described above in relation to FIG. 1. The sales leads 104a-d are also described substantially above in relation to FIG. 1. The sales leads 104a-d are not organized sequentially in the shown example because they are distributed to sales campaigns 302a-b without regard to the order in which they were collected.

The system 350 also includes costs 114a-b. The costs 114a-b are substantially described above in relation to FIGS. 1-3A. In this embodiment, the costs 114a-b represent costs incurred in soliciting, or prosecuting, the collective sales leads 104a-d in a sales campaign 302. In other embodiments, the costs 114a-b may represent the costs incurred in prosecuting a particular sales lead 104a-d rather than an entire campaign 302. In still further embodiments, the costs 114a-d may represent those costs incurred by a particular salesperson 110 working for the seller client 108 to whom the sales lead 104a-d or sales campaigns 302a-b are delivered.

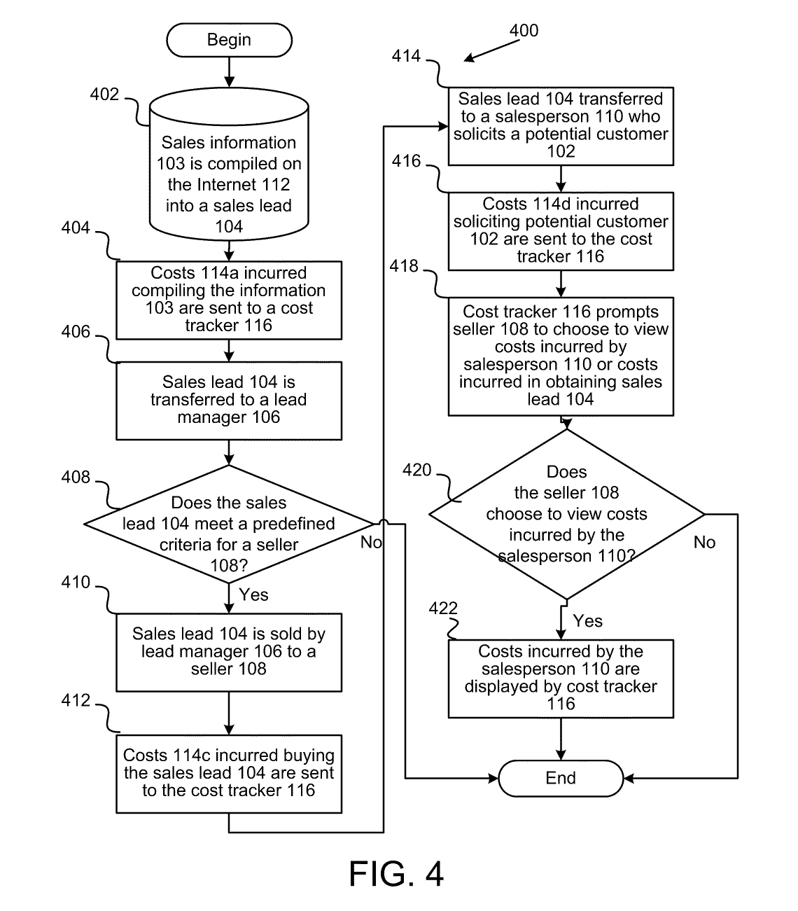

Referring now to FIG. 4, a method 400 for tracking costs associated with sales lead solicitation. FIG. 4 is a flow chart in accordance with one embodiment of the present invention. The method 400 substantially includes the embodiments and modules described above with regard to the apparatus and system depicted in FIGS. 1-3.

The method 400 begins and sales information 103 is compiled 402 on the Internet 112. This sales information 103, when complied, forms a sales lead 104. Costs 114a may be associated with generating the sales lead 104 on the internet 112, including CPC advertising costs and CPI advertising costs. In the shown embodiment, the sales lead 104 comprises a computer readable file.

The cost(s) 114a incurred in compiling the sales lead 104 are sent 404, in this embodiment, over a signal bearing medium to a cost tracker server 116. In some embodiments, the cost tracker server 116 may set a cumulative cost indicator included in the sales lead 104 in response to receiving the cost 114a. In other embodiments, the cumulative cost indicator may be stored outside the computer file comprising the sales lead 104 and made available to seller clients 108 by the cost tracker server 116.

The sales lead 104 is then transferred 406 to a lead manager server 106. The lead manager server 106 is described above in relation to FIG. 1.

If the lead manager server 106 determines 408 that the sales lead 104 meet a predetermined criteria for a seller client 108, the sales lead 104 is sold, in this embodiment, to the seller client 108, and the method 400 continues 410. If the lead manager server 106 determines that the sales lead 104 does not meet the predetermined criteria for seller client 108, the method 400 ends in this embodiment.

At 410, the lead manager server 106 sells 410 the sales lead 104 to the seller client 108, and transfers the sales lead 104 to the seller client 108. Costs 114c incurred buying, or acquiring, the sales lead 104 by the seller client 108 are sent 412 to the cost tracker server 116.

The sales lead 104 is transferred 414 from the seller client 108 to a salesperson 110, which salesperson solicits a potential customer 102 who is described in the information 103.

Costs 114d incurred by the salesperson 110 or the seller client 108 in soliciting the potential customer 102 are sent 416 to the cost tracker server 116. These costs 114d may include wages paid by the seller client 108 to the salesperson 110, costs involved in printing solicitation materials, long distance telephone costs, travel costs, and the like.

In this embodiment, the cost tracker server 116 prompts 418 the seller client 108 via a GUI to choose whether or not to view costs incurred by the salesperson 110. In other embodiments, the cost tracker server 116 may prompt the seller client 108 to select one of costs incurred per salesperson 110 in soliciting one or more sales leads, costs incurred per sales lead 104 by a seller client 108, and costs incurred per campaign 302 by a seller client 108.

If the seller client 108 chooses 420 to view the costs incurred by the salesperson 110, the cost tracker server 116 displays 422 the costs incurred by the salesperson 110 in soliciting the sales lead 104, and the method 400 ends.

If the seller client 108 chooses 420 not to view the costs incurred by the salesperson 110, the method 400 ends in this embodiment.

Referring now to FIG. 5, a user screen 500 showing illustrative sales lead prosecution costs displayed in a computer environment by a cost tracker. FIG. 5 is a user screen in a generic web browser showing the operations of a computer program product embodiment of the present invention. The user screen 500 includes a sample web browser window 502 comprising an address bar 504, a view salesperson button 506, a view sales lead button 508, a view campaign button 510, a date range 512, a grid 514, and salesperson 110a-c.

The operations of the computer program product 500 result in display shown on the sample browser window 502 on a GUI in one embodiment. The sample browser window 502 displays cost information related to salesperson 110a-c, sales leads 104, and a sales campaign 302. In the shown embodiment, the seller client 108 has an account with the lead manager server 106 and the cost tracker server 116, and the cost tracker server 116 is displaying account information comprising cost information associated with, and incurred by, the seller client 108, the salesmen 110a-c, acquiring the sales leads 104 and buying a sales campaign 302. The cost tracker server 116 transmits the cost information to the seller client 108 via the Internet 112 to help the seller client 108 track information relevant to efficiency in soliciting sales lead 104.

A web browser, such as the sample browser window 502, is well-known to those of skill in the art. A web browser is a software application that displays and interacts with human beings using text, video, audio, and the like, usually received over the Internet 112 or a LAN. Examples of web browsers include Internet Explorer, Mozilla Firefox, Safari and the like. Web browsers typically communicate using hyper-text transfer protocol (HTTP), but may communicate in other protocols well-known to those of skill in the art. The sample browser window 502, in this embodiment, contains several functional and non-functional elements described below. The sample browser window 502, in some embodiments, is populated by the display module 208.

Included in the sample browser window 502 is an address bar 504. The address bar 504 indicates the uniform resource locator (URL) with which the sample web browser 502 is communicating. In the shown embodiment, the seller client 108 is communicating through the sample browser window 502 with the cost tracker server 116.

Included in the sample browser window 502 is a view salesperson button 506, which changes the grid 514 to show the costs associated with the salesmen 110a-c.

Included in the sample browser window 502 is a view sales lead button 508, which changes the grid 514 to show the costs associated with the sales leads 104.

Included in the sample browser window 502 is a view campaign button 510, which changes the grid 514 to show the costs associated with the sales campaign 302.

In alternative embodiments, other buttons 506-510 might be included in the browser window 502, such as buttons enabling the display of costs associated with a particular call center, associated with sales leads 104 in a certain geographic area, and the like.

Included in the sample browser window 502 is a grid 514 comprising four columns, the columns entitled respectively: Name, New, Contacted, Quoted, and Booked. A list of salesmen 110a-c who work for, or are affiliated with, the seller client 108 are shown in column 1.

The grid 514, in this embodiment, shows in the second column the sales leads 104, that have been assigned to the salesperson 110a-c as well as costs associated with purchasing those sales leads 104. The third column includes an amount of sales leads 104 that the salesmen 110a-c have contacted to date and the costs incurred by a seller, associated with the seller client 108, in paying the salesperson 110a-c to contact said sales leads 104.

In the fourth column, the grid 514 shows an amount of sales leads 104 resulting in a quote to the potential customer 102 and the costs 114 incurred by the seller client 108 in generating those quotes. The fifth column of the grid 514 shows the number of sales leads 104 that have resulted in services being scheduled for potential customers 102 and costs 114 incurred by the seller client 108 in scheduling (or booking) the potential customers 102 for those services. In alternative embodiments, a sixth column (not shown) might include the number of potential customers 102 who have cancelled a booking after the booking was scheduled and the costs 114 incurred by the seller, associated with the seller client 108 in the cancellations.

Other embodiments of the present invention may include additional columns in the grid 514 showing additional information such as sales leads 104 which have been viewed, surveyed, lost, or are determined to be fake.

The grid 514 shows not only cost information, but also status information useful to seller clients 108 and salesperson 110. Because each of columns 2-5 in the grid 514 show the amount of sales leads 104 in the sales campaign 302 satisfying the predetermined criteria for inclusion in their respective columns 2-5, the present invention provides means for tracking not only costs, but other status indicators as well. Furthermore, the columns 2-5 in the shown embodiment each contain three rows. In other embodiments, a final row might show the totals for the statistics displayed in each of the columns 2-5.

In the shown embodiment, the information displayed in the grid 514 comprises information substantially described above in relation to FIGS. 1-4 and stored in the sales lead 104, the costs 114a-b, and the cost information.

In the shown embodiments, the sales leads 104 shown in the grid 514 constitute a sales campaign 302. Other embodiments of the present invention may show additional grids 514, and/or additional tracking information in the grids 514.

Included in the sample browser window 502 is a date range 512, which is settable by the seller associated with the seller client 108 or salesperson 110 to limit the tracking information in the grid 514 to a certain date range.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer-implemented method for automatically tracking the cost of sales leads to a seller client, the steps of said method comprising:
accessing a sales lead data storage repository, wherein the sales lead comprises information about a potential customer, said information comprising one or more of: age, address, gender, credit rating, email, telephone number, commercial or residential nature, title in residence, size of residence, price of residence, income, education, purchasing interests, and purchasing practices;
receiving cost information comprising one or more of: costs of generating a sales lead, costs of purchasing the sales lead, and costs of soliciting the potential customer;
setting a cumulative cost indicator associated with the sales lead in response to receiving the cost information; and
allowing one or more seller clients to access the cost information.

2. The method of claim 1, further comprising assembling the sales lead data into a sales campaign.

3. The method of claim 2, wherein the cumulative cost indicator is associated with the sales campaign rather than the sales lead.

4. The method of claim 1, wherein setting the cumulative cost indicator comprises setting a plurality of cumulative cost indicators each associated with a different seller client in a seller client list.

5. The method of claim 1, further comprising notifying one or more seller clients that the cumulative cost indicator has been set.

6. The method of claim 1, further comprising notifying the one or more seller clients that cost information is available in response to receiving the cost information.

7. The method of claim 1, further comprising:
prompting a human being via a graphical user interface (GUI) to select one or more of:
costs incurred per salesperson in soliciting one or more sales leads;
costs incurred per sales lead by a seller; and
costs incurred per campaign by a seller; and
displaying via the GUI one or more of:
costs incurred by a single salesperson in soliciting one or more sales leads in response to the human being selecting costs incurred per salesperson in soliciting one or more sales leads when prompted;
costs incurred per sales lead by a seller in response to the human being selecting costs incurred per sales lead by a seller when prompted; and
costs incurred per sales campaign by a seller in response to the human being selecting costs incurred by sales campaign by a seller when prompted.

8. The method of claim 1, further comprising systematically repeating the steps of claim 1 for each seller in a seller list.

9. The method of claim 1, wherein the sales lead comprises a computer database entry stored in one or more computer readable files on a computer readable storage device.

10. A computer program product comprising a computer readable medium having computer usable program code executable to perform operations for tracking costs associated with sales lead solicitation, the operations of the computer program product comprising:
accessing a sales lead data storage repository, wherein the sales lead comprises information about a potential customer, said information comprising one or more of: age, address, gender, credit rating, email, telephone number, commercial or residential nature, title in residence, size of residence, price of residence, income, education, purchasing interests, and purchasing practices;
receiving cost information comprising one or more of: costs of generating a sales lead, costs of purchasing the sales lead, and costs of soliciting the potential customer;
setting a cumulative cost indicator associated with the sales lead in response to receiving the cost information; and
allowing one or more seller clients to access the cost information.

11. The computer program product of claim 10, further comprising assembling the sales lead data into a sales campaign.

12. The computer program product of claim 11, wherein the cumulative cost indicator is associated with the sales campaign rather than the sales lead.

13. The computer program product of claim 10, wherein setting the cumulative cost indicator comprises setting a plurality of cumulative cost indicators each associated with a different seller client in a seller client list.

14. The computer program product of claim 10, further comprising notifying one or more seller clients that the cumulative cost indicator has been set.

15. The computer program product of claim 10, further comprising notifying the one or more seller clients that cost information is available in response to receiving the cost information.

16. The computer program product of claim 10, further comprising:
prompting a human being via a graphical user interface (GUI) to select one or more of:
costs incurred per salesperson in soliciting one or more sales leads;
costs incurred per sales lead by a seller; and
costs incurred per campaign by a seller; and
displaying via the GUI one or more of:
costs incurred by a single salesperson in soliciting one or more sales leads in response to the human being selecting costs incurred per salesperson in soliciting one or more sales leads when prompted;
costs incurred per sales lead by a seller in response to the human being selecting costs incurred per sales lead by a seller when prompted; and
costs incurred per sales campaign by a seller in response to the human being selecting costs incurred by sales campaign by a seller when prompted.

17. The computer program product of claim 10, further comprising systematically repeating the steps of claim 1 for each seller in a seller list.

18. The computer program product of claim 10, wherein the sales lead comprises a computer database entry stored in one or more computer readable files on a computer readable storage device.

19. A computer system for automatically managing and delivering sales leads to a seller of a product, the system comprising:
an access module configured to access a sales lead data storage repository, wherein a sales lead comprises information about a potential customer;
a reception module configured to receive cost information comprising one or more of: costs of generating a sales lead, costs of purchasing the sales lead, and costs of soliciting the potential customer;
a configuration module configured to set a cumulative cost indicator associated with the sales lead in response to receiving the cost information; and
an allowance module configured to allow one or more seller clients to access the cost information.

20. The system of claim 19, wherein the information comprises one or more of: age, address, gender, credit rating, email, telephone number, commercial or residential nature, title in residence, size of residence, price of residence, income, education, purchasing interests, and purchasing practices.
